(19) United States
(12) Patent Application Publication
(10) Pub. No.: US 2005/0120816 A1
(43) Pub. Date: Jun. 9, 2005

(54) Satellite gearing

(76) Inventor: Herwig Fischer, Poznan (PL)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/501,615

(22) PCT Filed: Jan. 15, 2003
(86) PCT No.: PCT/EP03/00355

(30) Foreign Application Priority Data
Jan. 18, 2002 (DE) 102 01 738.7

(51) Int. Cl. F16H 25/04; F16H 27/00

(52) U.S. Cl. 74/112

(57) ABSTRACT

The invention relates to a compensation control with which the irregularities of satellite gearings can be completely or partially compensated. To this end, the relative movement in the transmission elements is altered in order to permit radial movements also in additional grooves of the satellites. In another embodiment, the transmission pins are not guided inside a fixed contour in the star-shaped disc, rather, the grooves of the star-shaped disc can move and are guided in a controlled path whereby effecting a compensation movement that increases the uniformity factor of the gearing.

The invention relates to a satellite transmission having an input element and an output element that can provide different transmission ratios by shifting into various concentric or eccentric positions and that include a ring with an annular groove and a star body with radial grooves, and satellites which are coupled to the ring and that transmit torque to the star body by means of coupling pins.

According to EP 0,708,896 a steplessly or nearly steplessly variable continuous-mesh satellite transmission is known having an input and an output element as well as several individual gears that generally form a satellite assembly that is in permanent mesh with a central wheel. If the ratio of the effective radii of the satellite assembly and the central wheel and the relative eccentricity of the satellite assembly and of the central wheel are changed by appropriate means, the transmission ratio between the input and output element is correspondingly changed. When eccentric to the central gear, the gears forming the satellite assembly pass cyclically through a torque-transmitting load zone and a load-free slip zone, the gears rotating either around the satellite-wheel axis or via one-way clutches around their own axes. On transitioning from the load-free zone to the load zone the gears transmit torque as a result of the continuous mesh and the blocked rotation.

Irregularities in the transmission of torque are cyclically compensated for at least partially by varying the radii in the load zone and/or the effective tangential components. In a concrete embodiment described in this publication, the coupling elements are mounted on the periphery of the input element and can assume different radial spacings at the output side in radial grooves there. The coupling elements are brought into mutual engagement by various direction-actuated force and/or surface arrangements so that at any time at least one coupling element is transmitting torque that corresponds to the highest angular speed in the output element.

EP 1,003,984 describes an improvement of such a drive with satellites or locking elements that are comprised of a one or multipart base body and a one or multipart contact body that lock together in a torque-transmitting position in the guide of the drive element, projecting locking-body pins or an element coupled with the locking body having two parts, that is two axially offset portions, in radial guides of the output element. The locking elements can according to one embodiment also have contact bodies with a nonround section, one surface of the contact body having a radius of curvature corresponding to the radius of curvature of the annular-groove wall of the ring disk and forming with this surface of the contact body in the torque-transmitting position a flat contact so that the Hertz pressure is minimized, the ratio of the radii being between 0.6 and 1.4.

According to a further variant of the invention that is described in German 199 53 643 there is a continuous-mesh one-way clutch in which an internally or externally toothed gear on a shaft is brought into engagement in a coupling direction with orbiting elements that are connected with another shaft, each of the orbiting elements engaging more than one tooth of the gear in continuous mesh. The orbiting elements execute as a result of the torque-transmitting angular force on the coupling pin a rotary or sliding motion, so that according to load direction they mesh with the gear or are pulled out of mesh with the gear.

In theory irregularities are the result of the fact that the effective radii change inside the load zone and in any zone in which the satellites are in mesh and thus the transmission ratio varies.

The varying radii which create the changes in transmission ratio are caused by the fact that the satellites on 15, the one hand orbits on the periphery of the ring and on the other hand are connected solidly with the radial groove of the star body. As a result the coupling pin slides radially inside the load zone, that is when the satellite is locked, and thus changes the effective radius for the transmission. When the transmission is set up such that the torque is transmitted from the ring to the star body (star disk), in theory the effective radius in the star disk is smaller than the orbit radius in the ring disk, since satellite transmissions work at high speeds, that is at high angular velocities, and the ratio of the effective radii determines the transmission ratio. It is understood that, in order to make the radii the same, the coupling pin must pass in the load zone at a predetermined ratio through a compensation path of for example 1 mm, with an assumed drive radius of 20 mm and a transmission ration of i=2 the output radius is 10 mm, whereby the compensatory movement of 1 mm forms 10% of the output radius. Compensating at the input radius has the effect that the change of 1 mm is only 5% of the input radius, so that the negative effect of the radius variation is cut in half. Similar considerations apply to the angular variation of the peripheral forces. Without going into detail about the kinematics, it is clear that the irregularities can be substantially reduced when radial compensation is carried out at the input side and not in the travel path of the output. In effect kinematics at a transmission ratio of i=2 and of i=1 create a completely uniform force transmission and at other ratios minimal irregularities.

It is an object of the present invention to wholly or at is least partially compensate out transmission irregularities.

This object is achieved by the satellite transmission of claim 1.

According to the invention in order to reduce or eliminate irregularities by varying the effective radius in the load zone each satellite has a radial groove in which can move the respective coupling pin at least relative to a center of the ring.

Preferably the radial groove is constructed such that it at least generally permits no movement of the coupling pin toward or away from the center of the star body.

In a first embodiment the radial grooves of the satellites are so long that the entire compensatory movement both in the load zone and in the slip zone can take place in these radial grooves. The star disk in this case is a disk on which the coupling pins are fixed and these pins can slide radially in the grooves and transmit torque angularly.

In a further embodiment the radial grooves of the satellites are only long enough that the compensator movement in the load zone is sliding in these radial grooves and the compensator movement in the slip zone is in grooves of the star disk or in coupling elements or similar known force-transmitting members.

According to a further embodiment of the invention as a result of the relative geometric relationships and/or the coefficient of friction, the coupling pins in the groove of the star body moves more easily in the slip zone, that is when moving through the load-free zone, than in the radial grooves so that the sliding movement in the slip zone takes place in the grooves of the star body and in the load zone in the grooves of the satellites.

Preferably the coupling pin is of greater diameter in the groove of the star body than in the radial groove of the satellites.

In particular according to the invention load flanks of the grooves have greater sliding or rolling friction as a result of surface type and/or shape relative to the contact flanks of the coupling pin or slide bodies carried by the coupling pin than the slip flanks and/or the grooves or that oppositely the load flank has less resistance than the slip flank. An increase of the sliding friction can be achieved by forming teeth in the pin and the groove of the star disk between the confronting flanks since the coupling pin or a slide body connected to it always engages one flank in the load zone and the opposite side in the slip zone. A further possibility to influence the coefficient of friction is to use a slide body with sleeves of different diameters in each of the two radial grooves so that under load the sliding or rolling friction is changed in the desired manner.

According to a further variant the coupling pin is fitted in a slide body that like a sprag according to load direction can wedge in one of the two radial grooves so that in the slip zone or in the load zone sliding takes place in the desired direction. It is also possible simply to prevent rotation of coupling elements by appropriate means in the load zone and thus shift the relative movement to the satellite groove.

In order to ensure that sufficient space is left for movement in the load zone, preferably the coupling pin is spring biased in the slip zone into an end of the groove so that much of the groove is available for radial compensation in the load zone. The spring-loading ensures that the coupling pin slides in the slip zone in the star-disk groove since the spring prevents sliding in the load zone. As soon as the load zone is reached, the angular force increases radically so that the satellite catches and transmits the applied torque. The sliding movement of the coupling pin in the star disk is subjected to increased friction, this effect being achieved by appropriate construction of the pin and groove so that the sliding friction in the groove of the satellite is less than in the star disk.

One respective slide body is provided between the coupling pin and the groove of the satellite or of the star disk so as to convert the Hertz pressure into surface contact. Such slide bodies are shown for example in EP 1,003,984.

Alternatively it is possible, in order to reduce or eliminate irregularities of the satellite transmission to use slide bodies with a particular shape or construction such that like locking bodies, rollers, or free-running clutches according to the load direction they slide or lock in the radial grooves so that the load-direction change is initiated on entry into the load zone from the satellite groove or the radial groove and is reversed on leaving.

The radial grooves in the star disk have a stop that sets a variable minimum radius for each transmission ratio and thus forces the coupling pin to use the radial groove on the satellite when in the load zone for geometric compensation.

According to the prior-art embodiments the star disk has geometrically fixed radial grooves. Instead of this it is possible to form the radial grooves with guide elements that are mounted on a disk such that a width of the grooves is varied according to the load direction of the coupling pin. If the guide elements are moved together, the radial groove between them narrows so that the coupling pin is clamped and it cannot move in the groove. The same is true for slide bodies that are connected to the coupling pins and are clamped in the load zone in order to prevent them from moving radially.

According to an alternative embodiment to achieve the object of the invention the radial grooves of the star body are mounted in separate radial guides that can move relative to the disk. Preferably the radial guides are freely pivotal. Control of the movement of the radial guides is effected preferably by a groove 31 of the ring whose position relative to the eccentric shifting direction for ratio control is fixed.

According to a further embodiment of the invention the satellites have as described in German 199 56 643 teeth that mesh in the load zone with complementary teeth of the hollow ring disk, the satellite pivoting when moving between the load zone and the slip zone. For solid blocking, the torque effective on the satellites when they are not perfectly position and when they are badly lubricated must always be greater than the friction movement that is a function of the frictional force and the spacing of the first teeth to mesh from the satellite pivot axis.

Further embodiment and the associated advantages are seen in the drawing and discussed in the following description.

In a further embodiment the object is achieved the star body is formed by a support disk with individually secured radial segments that rotate about axes collinear to the drive axis so that they always lie in positions parallel to the support disk. Preferably this rotation is opposed to a stabilizing moment created by a spring and/or damper so that angular force pulses that result from irregularities, are spring damped. In a preferred embodiment the pivot axes of the radial segments lie on an edge line on the support disk on which the satellites ride when the ring and the star body are concentric, that is with a transmission ratio of 1:1, so that the amount of spring biasing or damping is greater as the eccentricity of the support disk to the ring disk increases. The effect of the spring biasing is 0 with a 1:1 ratio.

There is shown in:

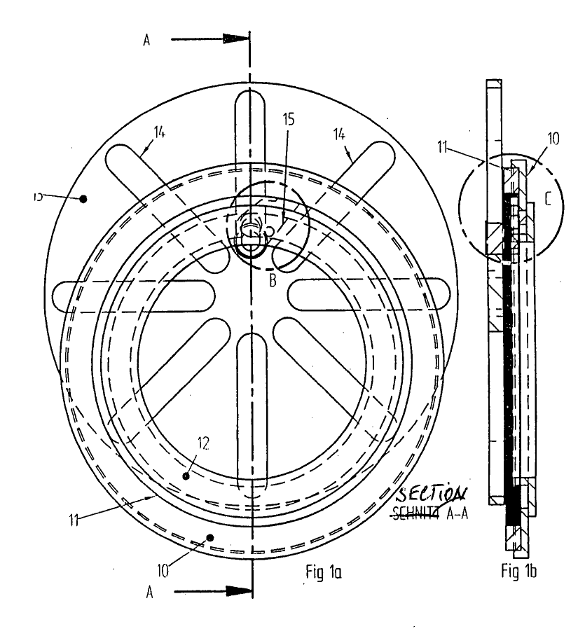

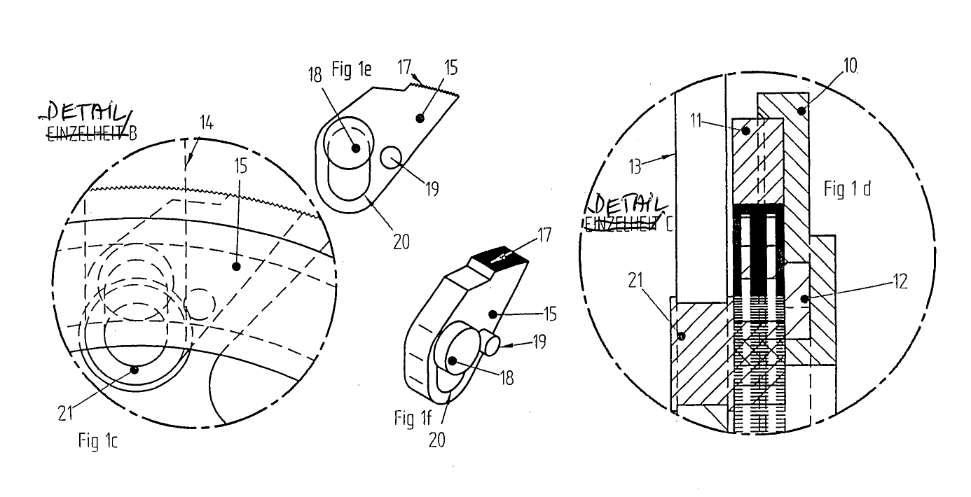

FIG. 1a a top view of a satellite transmission according to the invention in schematic view;

FIG. 1b is a section taken along line A-A of FIG. 1;

FIG. 1c is a view of the detail indicated at B in FIG. 1a;

FIG. 1d is a view of the detail indicated at C in FIG. 1b; and

FIGS. 1e and f are views of a satellite according to the invention;

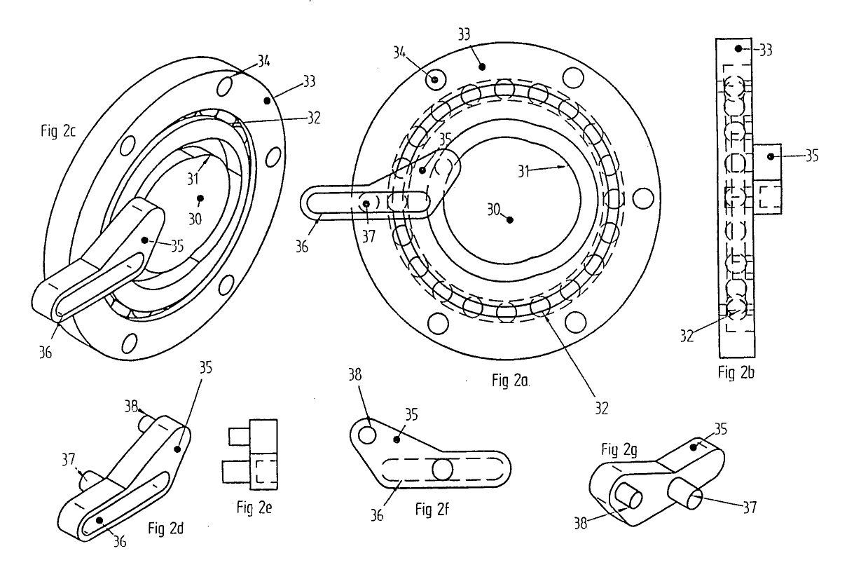

FIGS. 2a to c are views of a further embodiment of the satellite transmission; and

FIGS. 2d to g are views of a satellite according to the invention;

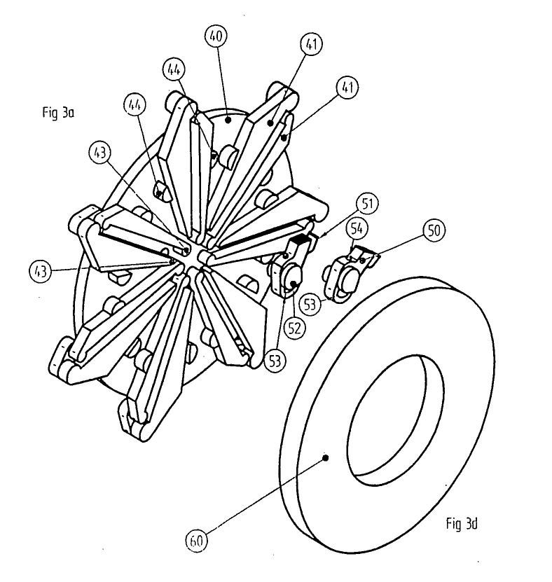

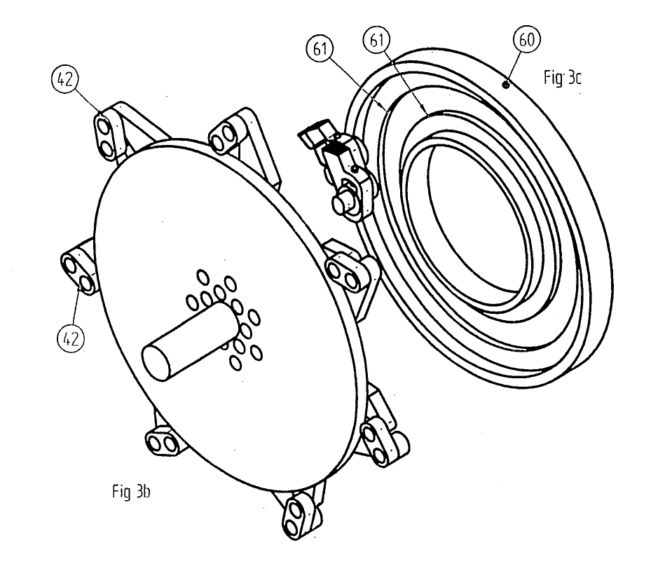

FIGS. 3a and b are perspective views of a star disk with adjustable radial grooves; and

FIGS. 3c and d are perspective view of a ring;

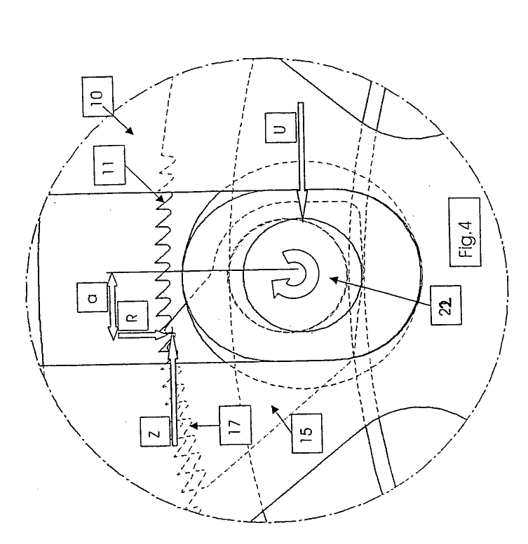

FIG. 4 is a diagram showing a satellite rotating in mesh with a ring disk; and

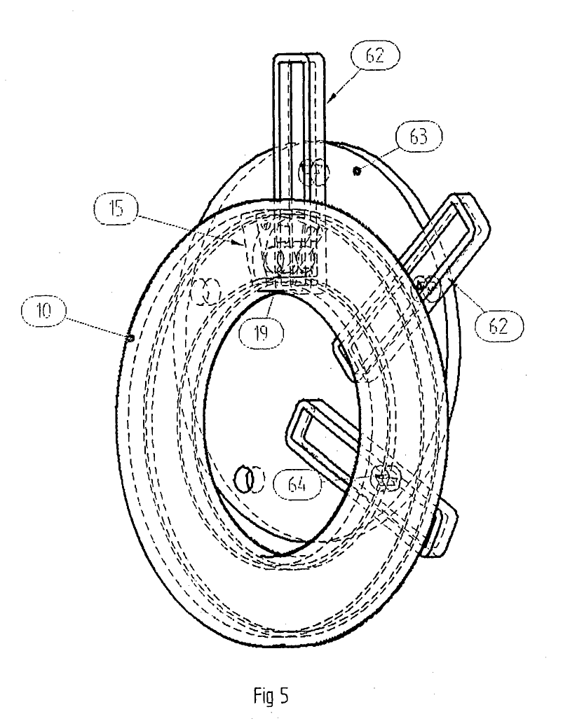

FIG. 5 is a perspective view of another embodiment.

The satellite transmission shown schematically in FIG. 1 has a ring 10 that is formed as a hollow disk with internal teeth 11. This ring 10 further has an annular groove 12 in which the satellites move circularly as sprags. The ring 10 is the input element. The output element is a star disk 13 with radial grooves 14. The applied torque is transmitted via satellites 15 when their teeth 17 are engaged with the teeth 11 of the ring. Each satellite is held by an integral guide part 18 in the groove 12. Another integral pin 19 of each satellite prevents the satellite from flipping over when decoupled since it also engages the groove 12 when a predetermined angle is reached.

According to the invention a radial groove 20 in the satellite allows a pin 21 to make a compensating movement radially of the ring 10. The diameter of the pin 21 is different from the width of the groove 20 in the satellite and the groove 14 in the star disk so that it rides more readily in the radial groove 20 than in the groove 14 in particular when it is bearing under load against a flank of the groove 14.

According to a further embodiment of the invention it is possible to provide an unillustrated biasing spring that holds the pin 21 in the groove 20 in the desired end position, that is at the very end of the groove 20, so that the entire radial distance is available for radial compensation when under load.

FIGS. 2a to c show an inner stationary disk 30 with a cam groove 31 and on which ride balls 32 that rotationally support an outer rotatable disk 33. Coupling pins 37 corresponding to the pins 21 of FIG. 1 and engaged in bores 34 carry radial guides 35, of which only one out of six is shown.

Radial slots 36 receive the coupling pins 37 coupled with the unillustrated elements of the drive disk. The radial guides 35 can rotate about the coupling pins 37, this rotation being controlled by pins 38 that ride in the cam groove 31. With this system the radial grooves always execute a corrective movement at the same place, that is when under load, so that irregularities are reduced.

In another embodiment shown in FIGS. 3a to d the star disk is not provided with geometrically fixed radial grooves, but instead has a disk 40 with guide elements 41 interconnected by links 42 and pivotal about axles 43. The relative positions of the axles 43 and the orientations of the links 42 is such that the radial grooves formed between the guide elements 41 in which the coupling pins 52 of the satellites 50 slide are restricted as soon as the guide elements 41 rotate about their axles 43 in the rotation direction of the transmission. This rotation is limited by stops 44. On entry into the load zone, each satellite 50 is coupled up and the load direction changes so that the guide elements 41 which when slipping rest against the stops 44 rotate about the axles 43 and make the radial grooves narrower. Since the coupling pin 52 is in the radial groove, its rotation is blocked as soon as the groove width is less than the diameter of the coupling pin which is immediately clamped so that it cannot move radially. Further compensatory movement can take place only in the grooves 53 of the satellites 50 so that there is an automatic transfer of the compensatory movement on entry into the load zone. On leaving the load zone, the cycle takes place analogously in reverse.

In an embodiment with coupling elements, their rotation is prevented in the load zone by an appropriate mechanism so as to shift the relative movement to the satellite groove.

Another possibility of minimizing irregularities is by fixing the radial grooves of the star disk individually such that rotation there is not only rotary movement but also combined rotary/translatory movement. This movement is controlled by a guide pin that rotates in a cam groove that is fixed on the stationary disk. The radial grooves control the described movement at a fixed position relative to the eccentricity, that is for example always starting at the beginning of the load zone and terminating at or near the end of the load zone so that with the right shape of the cam groove irregularities are reduced.

The relative movement during force transfer is that much greater as the coupling movements move outward in the radial groove, so that this parameter of the cam is different for each eccentricity, that is with the same cam it is possible to accommodate any possible transmission ratio.

FIG. 4 shows a satellite 15 with particularly shaped teeth 17 that is fitted to the teeth 11 of a ring. The drawing shows the region between the slip zone and the load zone in which the satellite 15 pivots as shown by arrow 22. The illustrated angular force U is effective in the direction of the arrow via the eccentric coupling pin 21 on the satellite 15. The tooth force A is effective via the meshing of the teeth 17 of the satellite with the teeth 11 of the ring in the opposite direction so that the satellite orbits in the direction of the arrow. This rotation is opposite to the friction force R which is offset by a spacing a from the pivot axis and thus has a torque Mᵣ=R×a.

One is assured of a solid locking when the torque from the vectors U and Z no matter what the circumstances, that is even when the satellites are in the wrong position and with poor lubrication, is greater than the friction moment Mᵣ. In this case the satellite only assumes the full angular force when it is fully meshed (teeth 11 and 17) and cannot be stressed at the teeth tips. Taking into account all forces and torques, including unillustrated dynamic forces such as centrifugal or Coriolis accelerations that are effective at high angular speeds on the satellites 15 and the force-transmitting elements while considering the also unillustrated frictional torques on the coupling pins, the transmission is set up such that the sum of all locked torques (as shown by arrow 22) are always greater than the sum of opposite torques.

FIG. 5 shows a ring 10 with orbiting satellites 15 that each transmit load-carrying angular forces via a coupling pin 19 into radial segments 62 on a support disk 63. The pivot axes 64 allow rotation of the radial segments 62 that are stabilized by an unillustrated known spring damping element into a (radially extending) null position.

Alternatively the coupling pin 19 is set up such that it is fixed in the annular groove of the ring 10 and thus is fixed in the corresponding radial groove of a radial segment 62. In this manner the radial segments 62 are always directed toward the center of the ring 10.

### Reference Numeral List

ring 10
internal teeth 11.
annular groove 12
star disk 13
radial grooves 14.
satellites 15
satellite teeth 17
integral guide part 18
pin 19
satellite radial groove 20
pin 21
arrow (FIG. 4) 22
stationary disk 30
cam groove 31
balls 32
rotatable disk 33.
bores 34
radial guides 35,
radial slots 36
coupling pins 37
pin 38
disk 40
guide elements 41
sprags 42
axles 43
stops 44
satellites 50
radial groove 51
coupling pins 52
groove 53
ring 60
radial segments 61
radial segments 62
support disk 63.
pivot axes 64

1. A satellite transmission having an input element and an output element that can provide different transmission ratios by shifting into various concentric or eccentric positions and that include a ring (10) with an annular groove (12) and a star (13) with radial grooves (14), and satellites (15, 35, 50) which are coupled to the ring (10) and that transmit torque to the star b (13) by means of coupling pins (21, 52), characterized in that
in order to reduce or eliminate irregularities by varying the effective radius in a load zone, each satellite (15, 35, 50) has a radial slot (14, 51) in which can move the respective coupling pin (21, 51) when in the load zone at least relative to a center of the ring (10).

2. The satellite transmission according to claim 1, characterized by a radial groove (20, 51) whose length permits generally no movement of the coupling pin (21, 51) relative to a center of the star (13).

3. The satellite transmission according to claim 1, characterized in that as a result of the relative geometric relationships and/or the coefficient of friction, the coupling pins in the grooves (14) of the star b move more easily in the slip zone, that is when moving through the load-free zone, than in the radial grooves (20) so that the sliding movement in the slip zone takes place in the grooves (14) of the star (13) and in the load zone in the grooves (20) of the satellites (15).

4. (canceled)

5. The satellite transmission according to claim 3 or 4, characterized in that load flanks of the grooves (14) have greater sliding or rolling friction as a result of surface type and/or shape relative to the contact flanks of the coupling pin (21) or slide bodies carried by the coupling pin than the slip flanks and/or the grooves (20) or that oppositely the load flank has less resistance than the slip flank.

6. The satellite transmission according to claim 1, characterized in that the coupling pin (21) is spring biased in the slip zone into an end of the groove (20) so that much of the groove (20) is available for radial compensation in the load zone.

7. (canceled)

8. The satellite transmission according to claim 5, characterized in that the slide bodies have a shape or construction such that like locking bodies, rollers, or free-running clutches according to the load direction they slide or lock in the radial grooves so that the load-direction change is initiated on entry into the load zone from the groove (14) to the groove (20) and is reversed on leaving.

9. The satellite transmission according to claim 8, characterized in that the radial grooves (14) in the star (13) have a stop that sets a variable minimum radius for each transmission ratio and thus forces the coupling pin (21) to use the radial groove (20) on the satellite when in the load zone for geometric compensation.

10. The satellite transmission according to claim 9, characterized in that the radial guides are pivotal and that control of movement of the radial guides is effected by a groove (31) that is on a part whose position is fixed relative to the eccentric movement of the transmission control.

11. The satellite transmission according to claim 1, characterized in that the radial grooves are defined by guide elements (41) that are set up such that they can change the width of the radial groove according to the load directions of the coupling pins (52) that slide in the radial grooves.

12. The satellite transmission according to claim 11, characterized in that the radial grooves formed by the guide elements (41) can be narrowed so much that the coupling pins or the slide bodies connected with the coupling pins are clamped in the load zone and cannot move further radially.

13. A satellite transmission having an input element and an output element that can provide different transmission ratios by shifting into various concentric or eccentric positions and that include a ring (10) with an annular groove (12) and a star (13) with radial grooves (14), and satellites (15, 35, 50) which are coupled to the ring (10) and that transmit torque to the star b (13) by means of coupling pins (21, 52), characterized in that the radial grooves (36) of the star disk (33) are not fixed on the disk but instead are formed by separate radial guides (35) that can move relative to the disk (33) to reduce or eliminate irregularities.

14. The satellite transmission according to claim 13, characterized in that the satellites (15) have teeth (17) that mesh in the load zone with complementary teeth (11) of the hollow ring disk (10), the satellite (15) pivoting when moving between the load zone and the slip zone.

15. The satellite transmission according to claim 14, characterized by satellites (15) shaped such that on transitioning from the slip zone into the load zone the torque is greater than the torque that is the product of the frictional force (R) and the spacing (a) between the first teeth to mesh and the satellite axis.

16. A satellite transmission having an input element and an output element that can provide different transmission ratios by shifting into various concentric or eccentric positions and that include a ring (10) with an annular groove (12) and a star body (13) with radial grooves (14), and satellites (15, 35, 50) which are coupled to the ring (10) and that transmit torque to the star body (13) by means of coupling pins (21, 52), characterized in that
the star is formed by a support disk (63) with individually secured radial segments (62) that rotate about axes collinear to the drive axis so that they always lie in positions parallel to the support disk (63).

17. The satellite transmission according to claim 16, characterized in that the radial segments (62) are stabilized in their radial positions by springs and/or dampers.

18. The satellite transmission according to claim 16, characterized in that the coupling pin (19) of the satellite (15) fits snugly in the annular groove of the ring (19) and also fits snugly in the radial groove of the radial segment (62).

19. The satellite transmission according to claim 16, characterized in that the pivot axes of the radial segments (62) lie on an edge line on the support disk (63) on which the satellites (15) ride when the ring (10) and the star (62, 63) are concentric.

20. The satellite transmission according to claim 16, characterized in that the radial segments (62) are set in a guide of the coupling pin (19) that, when the ring (10) and the star (62, 63) are eccentric, they are oriented at least generally in line with the center of the ring (10).

21. A variable-speed transmission comprising:
a ring centered on and rotatable about a ring axis and formed with a circular track and with a radially inwardly directed circular coupling surface both centered on the ring axis;
a star centered on and rotatable about a star axis substantially parallel to the ring axis and formed with a plurality of radial tracks extending substantially radially of the star axis, the ring and star being relative displaceable perpendicular to their axes between an eccentric position with the axes offset from each other and a coaxial position with the axes coaxial;
a plurality of satellites angularly spaced about and riding in the ring track and each having an outer end bearing on the coupling surface, whereby the satellites are each maintained at a substantially fixed radial spacing from the ring axis by the ring track and at a substantially fixed angular spacing from one another by the radial tracks, each of the satellites further being formed with a respective radially extending guide; and
respective coupling elements each riding in a respective one of the radial tracks and a respective one of the guides and thereby angularly coupling the satellites angularly with the star, whereby each relative rotation about one of the axes of the ring and star in the eccentric position orbits the satellites through a load zone in which their outer ends are coupled to the coupling surface and transmit torque between the ring and star and a slip zone in which their outer ends move along the coupling surface and transmit no torque.

22. The variable-speed transmission defined in claim 21 wherein the outer end of each satellite and the coupling surface of the ring are formed with generally complementary interengaging teeth.

23. The variable-speed transmission defined in claim 21 wherein the tracks are grooves.

24. The variable-speed transmission defined in claim 21, further comprising
means between the coupling elements and the tracks for inhibiting but not preventing sliding of the coupling elements on the respective radial tracks while substantially not inhibiting sliding of the coupling elements on the circular track.

25. The variable-speed transmission defined in claim 21 wherein the tracks are grooves and coupling elements each have a large-diameter end in the respective radial groove track and a small-diameter end in the circular track.

26. The variable-speed transmission defined in claim 21 wherein the radial tracks and portions of the coupling elements that engage the radial tracks have a greater coefficient of friction than the circular track and portions of the coupling elements that engage the circular track.
